(19) United States
(12) Patent Application Publication
(10) Pub. No.: US 2015/0159279 A1
(43) Pub. Date: Jun. 11, 2015

(54) PROCESS FOR OBTAINING A PLURALITY OF LAMINAS MADE OF A MATERIAL HAVING MONOCRYSTALLINE STRUCTURE FROM AN INGOT

(71) Applicant: David Callejo Munoz, Milan (IT)

(72) Inventor: David Callejo Munoz, Milan (IT)

(21) Appl. No.: 14/481,667

(22) Filed: Sep. 9, 2014

(30) Foreign Application Priority Data
Dec. 5, 2013 (IT) AN2013A000231

(51) Int. Cl. C23F 1/02; B29C 69/00

(52) U.S. Cl. CPC C23F 1/02; B29C 69/001; B29L 2007/00

(57) ABSTRACT

A method is described for obtaining a plurality of laminas made of a material having monocrystalline structure, by detachment from an ingot made of the material having monocrystalline structure, the ingot having an axis of symmetry (X), the method comprising: creating, in the ingot by use of a pulsed laser beam, a plurality of sacrificial layers with modified crystalline structure, the plurality of sacrificial layers being distributed along the axis of symmetry (X), the plurality of sacrificial layers dividing the ingot in a plurality of residual layers; subjecting the plurality of sacrificial layers to chemical etching, thereby causing a separation of the residual layers; and detaching the residual layers to produce the plurality of laminas made of a material having monocrystalline structure.

### PRIORITY FOREIGN PATENT APPLICATION

This is a non-provisional national phase U.S. patent application claiming priority to a pending Italian patent application, Serial No. AN2013A000231, filed in Italy on Dec. 5, 2013 with a common inventive entity. This present U.S. patent application draws priority from the referenced foreign patent application under 35 U.S.C §119. The entire disclosure of the referenced foreign patent application is considered part of the disclosure of the present U.S. patent application and is hereby incorporated by reference herein in its entirety.

### DESCRIPTION

The following is a description of a process for obtaining a plurality of laminas made of a material having monocrystalline structure, by detachment from an ingot made of a material having a monocrystalline structure.

For the purposes of the present description, the term “lamina” means an element having two large surfaces and a thickness of between 10 nm and 1500 nm.

The term “lamina” includes elements with two large parallel surfaces (flat or curved) having a substantially and/or generally constant thickness.

The term “lamina” also includes elements with two large non-parallel surfaces.

For the purposes of the present description, the term “lamina made of a crystalline material” includes crystalline materials having, on their two large surfaces, the same crystallographic orientation.

For the purposes of the present description, the term “material having monocrystalline structure” includes synthetic corundum.

For the purposes of the present description, the term “ingot” includes bodies having an axis of symmetry, in particular bodies having an axis of symmetry and a cross-section that, at least in one section, is substantially and/or generally constant.

Corundum is a transparent material, with chemical formula Al2O3, which crystallizes in the trigonal system.

In nature, corundum is usually coloured, due to the presence of impurities.

Among the different varieties of corundum found in nature are, in particular, ruby (whose red colour is due to small quantities of chromium) and sapphire (whose dark blue colour is due to the presence of iron and titanium).

Methods for synthesizing corundum ingots are also known.

For example, corundum can be produced in the laboratory in the form of cylindrical bars by means of melt growth techniques, such as the Czochralski method, the Kyroupolus method, or in various forms, by means of the Stephanov method.

Corundum has some interesting physico-chemical properties: high hardness (second only to that of diamond), high chemical inertia and excellent transparency.

Synthetic corundum, in the form of laminas, thanks to its high breaking strength and scratch resistance and its high chemical inertia, can be used, for example, to make transparent screens, such as screens of transparent lamination layers in which at least one of the lamination layers is composed of corundum.

Corundum can therefore be used to make screens for optical sensors (destined to be exposed to aggressive external agents) and transparent protective screens for the monitors of electronic devices, such as sat nays, laptop computers, smartphones and tablets.

However, the physico-chemical properties for which corundum is valued, such as hardness and chemical inertia, make its machining, particularly cutting and machining operations (such as lapping) aimed at reducing its surface roughness, complex and expensive.

Traditional systems for cutting corundum laminas are based on using multi-wire saws with diamond metal wire.

This technology requires long machining times and is quite expensive.

As an example, it takes about 18 hours of machining to cut 200 laminas of corundum, with a cross-section of about 150 mm and a thickness of 1 mm.

Due to the costs of the necessary equipment, the operating costs (particularly the consumption of diamond wire) and the time required to perform the cut, the cost of a corundum lamina (excluding the material) is so high as to make corundum uncompetitive compared with other materials such as Gorilla® glass.

Another drawback of using diamond wire to cut corundum laminas is that, in fact, it is not possible to obtain corundum laminas less than about 500 μm thick (below this thickness threshold the frequency of rejects drastically increases).

At ambient temperature for thicknesses of more than 450-500 μm, corundum laminas have a substantially rigid behaviour.

However, the tendency of the latest generations of monitors for electronic devices, such as smartphones, is to adopt curved geometries (portions of cylindrical surfaces for example).

Consequently, it is not possible to make monitors with corundum screens, with curved geometries, by adopting the technology of cutting by means of diamond wire.

Below the threshold of 450 μm, the corundum laminas begin gradually to have an increasingly more flexible behaviour with a minimum radius of curvature inversely proportional to the thickness of the lamina.

In particular, below 400 μm thick corundum laminas start to have sufficient flexibility to enable them to be used to make monitors with a curved geometry.

Another drawback of the above-described prior art is that the laminas obtained can only be laminas with flat large surfaces parallel to each other.

Yet another drawback of cutting by means of diamond wire is that the mechanical process of cutting causes structural damage beneath the surface of the material (so-called “subsurface damage”) of a depth proportional to the particle size of the diamond dust present on the cutting wire.

This thickness, indicatively 30 μm on each side of the cut sheet, must be removed before polishing said sheet.

Consider also that the machining required to reduce surface roughness, in addition to requiring time, is very delicate in that it can cause irreparable damage to the corundum sheet.

It will also be remembered that corundum has a high density (around 4 g/cm3).

With the thicknesses obtainable using the existing cutting technology, the protective monitor screens, if made using corundum laminas, would be heavier than the monitors made using Gorilla® glass and therefore of little interest to the consumer electronics market, particularly in the case of monitors for portable devices such as laptops and smartphones.

Furthermore, cutting with diamond wire involves a waste of material, in the best cases, of at least 180-200 μm, which means that to obtain, for example, 200 1 mm-thick corundum laminas, an ingot of a length of at least 240 mm is required.

The inventor's aim is to resolve, at least in part, at least some of the problems of the prior art and, in particular, the problems mentioned above.

The inventor's aim is achieved by means of a method according to claim 1.

Further advantages can be obtained by means of the additional characteristics of the dependent claims.

A possible embodiment of a method for obtaining a crystalline material in the form of laminas will be described below with reference to the accompanying drawings, in which:

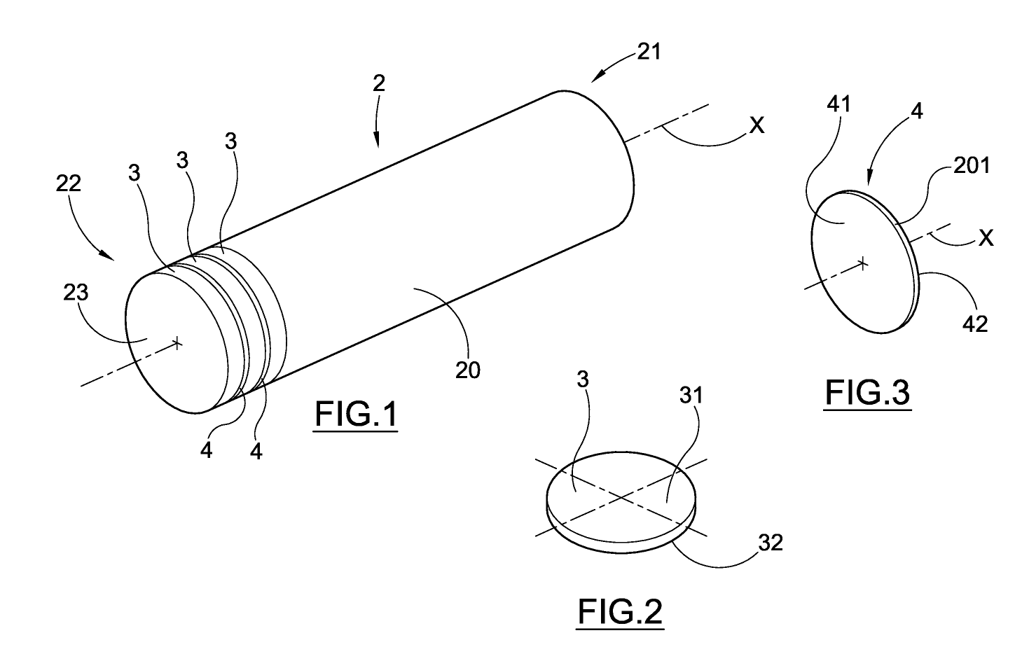

FIG. 1 is a schematic view of a corundum ingot;

FIG. 2 is a schematic view of a corundum lamina obtained from the ingot of FIG. 1;

FIG. 3 is a schematic view of a sacrificial layer made in the ingot of FIG. 1;

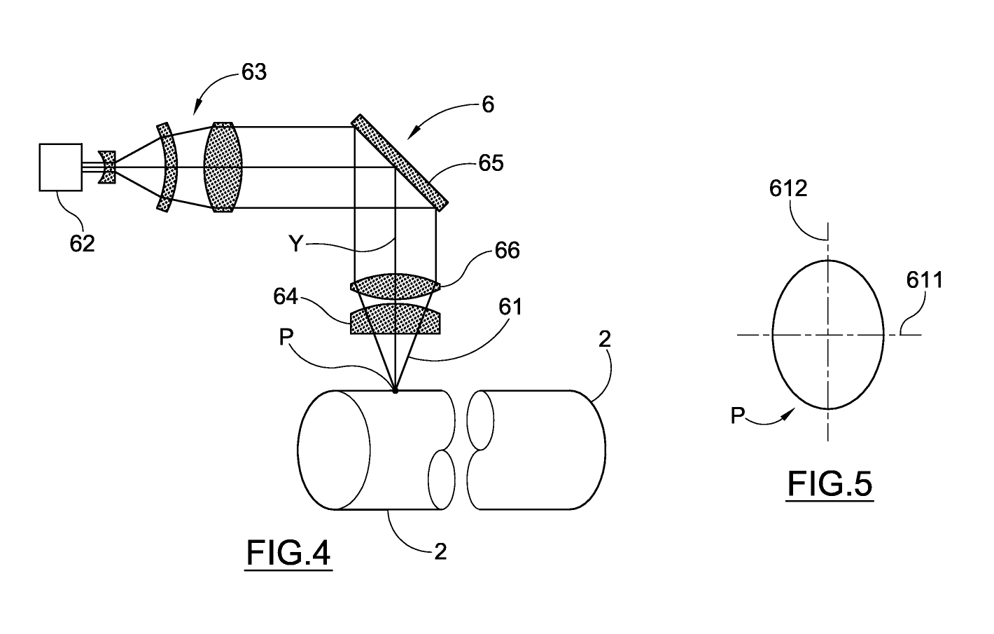

FIG. 4 is a schematic view of a laser device for creating sacrificial layers in the ingot of FIG. 1; and

FIG. 5 is a schematic view of a focal point obtained with a pulsed laser.

With reference to the accompanying drawings, a method is described for obtaining a plurality of laminas 3, 3, . . . 3 made of a material having a monocrystalline structure, such as corundum laminas.

Each lamina 3 has two large surfaces 31, 32.

This method involves detaching the laminas 3 from an ingot 2 after creating a plurality of sacrificial layers 4, as will be better described below.

The ingot 2 has a substantially and/or generally straight axis of symmetry X, in the form of embodiment illustrated, the ingot 2 has a cross-section which, at least in one section, is substantially and/or generally constant.

In a possible embodiment of the method, the ingot 2 is a bar of monocrystalline corundum, for example a bar of corundum with a circular or quadrangular section obtained by means of the Czochralski process.

The ingot 2 has a lateral surface 20, which develops around the axis of symmetry X of said ingot 2, and two distal ends 21, 22.

One distal end 22 of the ingot 2 can have a surface 23 that is substantially flat and/or generally orthogonal to the axis of symmetry X of the ingot 2.

The flat surface 23 can be obtained, for example, by cutting, with a diamond wire, a distal end of a corundum bar 2 obtained using the Czochralski method.

To obtain from the ingot 2 a plurality of corundum laminas 3, 3, . . . 3, the step of creating a plurality of sacrificial layers 4, 4, . . . 4 having a modified crystalline structure compared with the base material is envisaged.

The sacrificial layers 4, 4, . . . 4 develop orthogonally to the axis X of the ingot 2 and divide the ingot 2 into a plurality of residual layers 3, 3, . . . 3 destined to become corundum laminas.

The modification of the crystalline structure involves a reduction in the chemical inertia at the sacrificial layers 4, 4, . . . 4.

Since this material is destined to be sacrificed, the thickness of the sacrificial layers 4, 4, . . . 4 is as small as possible.

The distance between each pair of successive sacrificial layers 4, 4 determines the thickness of the lamina 3 that is desired.

The form of the sacrificial layers 4, 4, . . . 4, is conjugated to the form of the large surfaces 31, 32 of the laminas 3, 3, . . . 3 that are desired.

In the example illustrated, which refers to making corundum laminas 3 with large flat surfaces 31, 32 that are parallel to each other, each sacrificial layer 4 is delimited by two flat surfaces 41, 42 that are parallel to each other and orthogonal to the axis X of the ingot, and by a portion 201 of the lateral surface 20 of the ingot 2, located between the intersections of the two flat surfaces 41, 42 with the lateral surface 20.

In order to create each sacrificial layer 4, the crystalline material of the ingot 2 must be irradiated with a pulsed laser beam 61 (so-called “femtosecond laser” or “ultrafast laser”).

For this purpose a laser generator 6 is provided, which comprises a laser source 62, a system for transporting the laser beam 63, a focuser 64 and a system for moving the laser beam 65.

The pulsed laser beam 61 has an optical axis Y on which there is a focal point P.

The pulsed laser beam 61 has a sufficiently high pulse power/average power ratio to minimize the induced thermal load on the material of the ingot 2 and thus limit the transmission of heat.

At focal point P, where the light energy is concentrated, the crystalline material suffers structural damage and, consequently, a reduction in chemical inertia.

By scanning (in depth) the ingot 2 with the focal point P, sacrificial layers 4, 4, . . . 4 are created (with modified crystalline structure and consequently less chemical inertia than the base material).

The creation of the sacrificial layers 4, 4, . . . 4 is immediately obvious because the material changes its optical properties, in particular at the sacrificial layers the corundum tends to lose transparency.

The system for moving the laser beam 61 may comprise a complex optical system, with a variable-focus lens 66 and one and/or more movable mirrors 65, to alter the depth of the focal point P in the ingot 2.

In order to scan the focal point P inside the ingot 2 a system of alternating linear rotation or movement of the ingot 2 (not shown) may be provided.

At the focal point P the laser beam 61 may have an elliptical section, with a small axis 611 (parallel to the axis of symmetry X of the ingot 2) and a large axis 612 (orthogonal to the axis of symmetry X of the ingot 2).

The size of the small axis 611 is as small as possible, so as to minimise the thickness of each sacrificial layer 4, whereas the maximum size of the large axis 612 is such as always to maintain a density of light output such as to damage the crystalline structure of the material of the ingot 2.

In a possible embodiment, the small axis 611 measures about 2 nm while the large axis 612 measures about 30 nm.

In practice the average thickness of the sacrificial layers 4, 4, . . . 4 can be between 2 nm and 10 nm.

In order to achieve the detachment of the laminas 3, 3, . . . 3 the sacrificial layers 4, 4, . . . 4 are removed by means of chemical etching.

Chemical etching may be done using hydrofluoric acid (HF), at a concentration by volume higher than 50%, at boiling temperature (about 150° C.), or a mixture to 50% by volume of sulphuric acid (H2SO4) and phosphoric acid (H3PO4), at boiling temperature (200° C. or above).

In a possible embodiment of the process, the ingot is arranged on a grid, for example a grid made of polytetrafluoroethylene (PTFE), that holds the laminas 3, 3, . . . 3 after dissolving the sacrificial layers 4, 4, . . . 4.

Using this method it is possible to obtain corundum laminas 3 with a minimum thickness of 10 nm with large surfaces 31, 32 of various conformations, in particular large surfaces 31, 32 that are flat and parallel to each other.

It is therefore possible to obtain corundum laminas of a thickness suitable to make transparent screens with a curved geometry and scratch resistance and breaking strength greater than that of other state-of-the-art screens (such as Gorilla® glass).

The interaction between the laser beam 61 and the material of the ingot 2 is influenced by the absorption coefficient of the corundum which, in turn, depends on the wave length of the incident radiation.

In a possible embodiment of the method, the pulsed laser beam 61 used to create the sacrificial layer 4 has a wavelength 2, in the range between 200 nm and 1,100 nm.

Preferably the pulsed laser beam 61 has a wavelength 2, of about 258 nm, 343 nm, 515 nm, 780 nm, 800 nm or 1,030 nm.

The repetition frequency f of the pulsed laser beam 61 is at least 10 kHz and, preferably, is higher than 1 MHz.

The duration τ of the pulses of the laser beam 61 is between 1×10⁻¹² seconds and 1×10⁻¹¹ seconds and, preferably, between 1×10⁻¹² and 1×10⁻¹⁰ seconds.

The peak energy density of the pulsed laser beam is at least 0.5 μJoules/nm2.

Thanks to the very short duration of the pulses of the pulsed laser beam 61 and to the high surface density, there is a non-linear interaction of absorption of the photons which causes an alteration of the properties of the irradiated material limited to the area of the focal point P.

Although not wishing to provide a scientific explanation, it is thought that the high energy density, in a time in the order of femtoseconds, generates damaging micro-explosions that create micro-fractures and/or transform the crystalline structure from monocrystalline to polycrystalline.

The lamina 3 thus obtained has no damage beneath its surface and has a roughness of less than 2 μm.

1. A method for obtaining a plurality of laminas made of a material having monocrystalline structure, by detachment from an ingot made of the material having monocrystalline structure, the ingot having an axis of symmetry (X), the method comprising:
creating, in the ingot by use of a pulsed laser beam, a plurality of sacrificial layers with modified crystalline structure, the plurality of sacrificial layers being distributed along the axis of symmetry (X), the plurality of sacrificial layers dividing the ingot in a plurality of residual layers;
subjecting the plurality of sacrificial layers to chemical etching, thereby causing a separation of the residual layers; and
detaching the residual layers to produce the plurality of laminas made of a material having monocrystalline structure.

2. The method according to claim 1 wherein the material having monocrystalline structure includes a material from the group consisting of: corundum, sapphire, diamond, ruby, quartz, silicon, silicon carbide, carborundum, fluorite, copper, germanium, gallium nitride, gallium arsenide, indium phosphide, padparadscha, tungsten, molybdenum oxide, and yttrium aluminum garnet (YAG).

3. The method according to claim 1 wherein the plurality of laminas each include at least two large generally parallel flat surfaces having a generally constant thickness and the same crystallographic orientation.

4. The method according to claim 1 wherein the plurality of laminas each include at least two large curved surfaces having a generally constant thickness and the same crystallographic orientation.

5. The method according to claim 1 wherein the plurality of laminas each include at least two large curved surfaces having a generally constant thickness and the same crystallographic orientation, the at least two large curved surfaces being curved in at least two dimensions.

6. The method according to claim 1 wherein the plurality of laminas each include at least two non-parallel surfaces.

7. The method according to claim 1 wherein the plurality of laminas each have a thickness of at least 10 μm.

8. The method according to claim 1 wherein the plurality of laminas each have a roughness less than 2 pm.

9. The method according to claim 1 wherein the sacrificial layers are substantially parallel to each other.

10. The method according to claim 1 wherein the sacrificial layers have a modified crystalline structure with a reduced chemical inertia.

11. The method according to claim 1 wherein the sacrificial layers each have a thickness no greater than 10 μm.

12. The method according to claim 1 wherein the pulsed laser is a femtosecond laser producing the pulsed laser beam with a femtosecond pulse duration.

13. The method according to claim 1 wherein the pulsed laser beam has a wavelength (λ) less than 1,100 nm, a repetition frequency (f) of at least 10 KHz, a pulse duration (τ) less than 1×10⁻¹⁰ seconds, and a peak energy density of at least 0.5 μJoules/μm².

14. The method according to claim 13 wherein the wavelength (2) corresponds to one of the following values: 258, 343, 515, 780, 800, 1030 nm, and wherein the repetition frequency (f) is higher than 1 MHz, and wherein the duration (τ) of the pulses is in the range between 1×10⁻¹² seconds and 1×10⁻¹⁰ seconds.

15. The method according to claim 1 including using a variable-focus lens to alter the depth of the focal point of the pulsed laser beam in the ingot.

16. The method according to claim 1 including using a variable-focus lens to alter the focal point of the pulsed laser beam to produce a beam with an elliptical section having a large axis orthogonal to the axis of symmetry (X) of the ingot.

17. The method according to claim 1 wherein the chemical etching is performed using hydrofluoric acid (HF), at boiling temperature, or a mixture of sulfuric acid (H2SO4) and phosphoric acid (H3PO4), at boiling temperature.

18. The method according to claim 1 wherein the plurality of laminas have a flat or curved geometry in a three dimensional shape.

19. The method according to claim 1 including using the plurality of laminas as transparent protective screens for the monitors of electronic devices with a flat or curved geometry.
